(19) United States
(12) Patent Application Publication
(10) Pub. No.: US 2006/0059708 A1
(43) Pub. Date: Mar. 23, 2006

(54) Apparatus for cleaning semiconductor substrates

(76) Inventors: Tai-Gyun Kim, Gyeonggi-do (KR); Jong-Kook Song, Gyeonggi-do (KR); Sung-Bae Kong, Gyeonggi-do (KR); Han-Mil Kim, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/222,041

(22) Filed: Sep. 7, 2005

(30) Foreign Application Priority Data
Sep. 7, 2004 (KR) 2004-71391

(51) Int. Cl. F26B 3/00; F26B 25/06

(52) U.S. Cl. 34/351; 34/202

(57) ABSTRACT

The present invention relates to an apparatus for cleaning a semiconductor substrate. The apparatus has a chamber including a treating room and a drying room located on an upper portion of the treating room. A supply pipe and an exhaust pipe are provided in the drying room. The supply pipe supplies isopropyl alcohol. In the exhaust pipe, a fluid in the drying room is exhausted. The exhaust pipe is arranged at both sides of the drying room in parallel to an arrangement direction of wafers. A plurality of exhaust ports are formed in each of exhaust pipes.

### CROSS-REFERENCES TO RELATED APPLICATIONS

This application claims priority from Korean Patent Application No. 2004-71391, filed on Sep. 7, 2004, the contents of which is herein incorporated by reference in its entirety.

### BACKGROUND OF THE INVENTION

1. Field of the Invention

This invention generally relates to apparatuses for fabricating semiconductor devices and, more specifically, to an apparatus for cleaning a semiconductor substrate.

2. Description of the Prior Art

In fabricating integrated circuits on semiconductor wafers, semiconductor wafers are first cleaned in order to remove residual chemicals, small particles, and contaminants generated from during various fabricating processes. Specifically, when highly integrated circuits are fabricated, the process of cleaning minute contaminants attached to the surface of semiconductor wafers is very important.

The conventional process for cleaning semiconductor wafers includes etching or separating the contaminants on semiconductor wafers by chemical reaction, rinsing the liquid chemical processed semiconductor wafer by pure water, and drying the rinsed semiconductor wafer.

In a conventional wafer drying process, single wafer types are placed within a spin dryer-type device using centrifugal force. An example of the spin dryer is disclosed in U.S. Pat. No. 5,829,156. With increased circuit integration, however, it is difficult to completely remove minute water drops that remain on a wafer by a spin dryer in which centrifugal force is used, thereby leaving a large number of water marks are generated on the wafer after the drying process.

To overcome these problems, more recent methods for drying semiconductor substrates use organic compounds such as isopropyl alcohol. Typical examples of dryers using organic compounds include a vapor dryer, a Marangoni dryer, and a spray dryer. The Marangoni dryer is performed on dry substrates by a Marangoni effect using the low surface tension of IPA vapor. In accordance with the spray dryer, IPA vapor generated external to the chamber is injected in the chamber, and then deionized wafer previously adhered to a surface of a wafer is substituted with the IPA vapor.

FIG. 1 is a perspective view schematically showing a general device 2 for drying a wafer using the above-mentioned isopropyl alcohol. In FIG. 1, arrows indicate an air flow within the device chamber 920. The device 2 has a chamber 920 for providing a space capable of housing approximately 50 sheets of wafers W. The wafers W are disposed on a supporting plate and arranged in a line. A supply pipe 940 for providing a drying fluid (e.g., IPA vapors or nitrogen gases) is installed in the chamber 920. An exhaust hole 960, formed through one sidewall of the chamber 920 and connected to a pipe 980 to evacuate the gases from the chamber, while close to wafers W near the sidewall through which the hole passes, is relatively distant from wafers W at an opposite end of the chamber 920.

There are, however, many problems in the above-mentioned device 2. Since the exhaust hole 960 is formed at only one side of the chamber 920, the drying fluid in the chamber 920 flows only in the direction of the exhaust hole 960. For this reason, while the drying fluid is sufficiently provided to wafers adjacent exhaust hole 960, the drying fluid is not sufficiently provided to wafers located at the opposite end of chamber 920 from exhaust hole 960, thereby resulting in insufficient drying.

Accordingly, the need remains for methods and a cleaning apparatus capable of more uniformly providing a drying fluid or vapor to wafers within a drying chamber.

### SUMMARY OF THE INVENTION

An exemplary embodiment of the present invention is directed to a cleaning apparatus having a drying room in which a substrate is dried. A supporter is provided in the chamber. The supporter is arranged in the drying room and supports the substrate. At least one supply pipe and at least one exhaust pipe are arranged in the drying room. The supply pipe supplies a drying fluid or vapor (collectively “fluid”) into the drying room. A fluid in the chamber is exhausted in the exhaust pipe. A plurality of exhaust ports for sucking the fluid in the chamber to the exhaust pipe are formed in each of the exhaust pipes. Preferably, slots are formed in the supporter in order that the substrates are arranged in a line, and the exhaust pipe is arranged at both sides of the drying room along an arrangement direction of the substrate, respectively.

The exhaust ports of three through a number of the substrates disposed on the supporter may be formed in each of the exhaust pipes. The supply pipe is arranged at upper both sides along an arrangement direction of the substrates. The exhaust pipe may be located at a lower portion in the drying room. The exhaust pipe is located in the drying room, and the exhaust ports may be formed as a hole in the exhaust pipe. A suction device for compulsorily sucking a fluid in the drying room to the exhaust pipe is coupled to the exhaust pipe.

According to one embodiment, the entrance area of the exhaust ports becomes large as the exhaust ports become more distant from the suction device. In accordance with another embodiment, the exhaust ports are formed more densely as the exhaust ports become more distant from the suction device.

According to still another embodiment, each of the exhaust pipes has a main pipe and a plurality of subsidiary pipes. The main pipe is arranged to the outside along an arrangement direction of the substrates disposed on the supporter. The plurality of subsidiary pipes are branched from the main pipe to be inserted along sidewalls of the drying room. The exhaust ports area is formed at the end of the subsidiary pipe. A pipe having a suction device is connected to a center of the main pipe. The drying fluid may include isopropyl alcohol.

In addition, the cleaning device of the present invention includes a treating room and a chamber having a drying room. A chemical solution processing process or a rinsing process with respect to the substrate is performed in the treating room. The drying room is arranged on an upper portion of the treating room. A drying process is performed in the drying room. A supporter is arranged in the chamber. The supporter is movable between the treating room and the drying room and supports the semiconductor substrate. Additionally, a movable separating plate for separating or opening a space between the treating room and the drying room is further provided. A supply pipe for supplying a drying fluid is provided in an upper portion in the drying room, and an exhaust pipe where a fluid is exhausted is provided in a lower portion in the drying room. The exhaust pipe is respectively arranged at both sides in the drying room along an arrangement direction of the substrates, which are disposed on the supporter. A plurality of exhaust ports are formed in the exhaust pipe.

The present invention now will be described more fully hereinafter with reference to accompanying FIGS. 2 through 11, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity.

### BRIEF DESCRIPTION OF THE DRAWINGS

FIG. 1 schematically shows a flowing of a drying fluid in a conventional cleaning apparatus.

FIGS. 2 and 3 are a regular cross-sectional view and a lateral cross-sectional view of a cleaning apparatus according to a preferred embodiment of the present invention, respectively.

FIG. 4 is a perspective view of a supporter of FIG. 2.

FIG. 5 is a front view of an exhaust pipe of FIG. 2.

FIGS. 6 and 7 show various modification embodiments of the exhaust pipe of FIG. 7, respectively.

FIG. 8 shows that an exhaust pipe of another embodiment is inserted in the drying room.

FIGS. 9 and 10 show various modification embodiment of the exhaust pipe of FIG. 8, respectively.

FIG. 11 schematically shows a flowing of a drying fluid in a drying room of the present invention.

### DETAILED DESCRIPTION OF THE PREFERRED EMBODIMENT

The present invention will be described more fully hereinafter with reference to the accompanying drawings in which exemplary embodiments of the invention are shown.

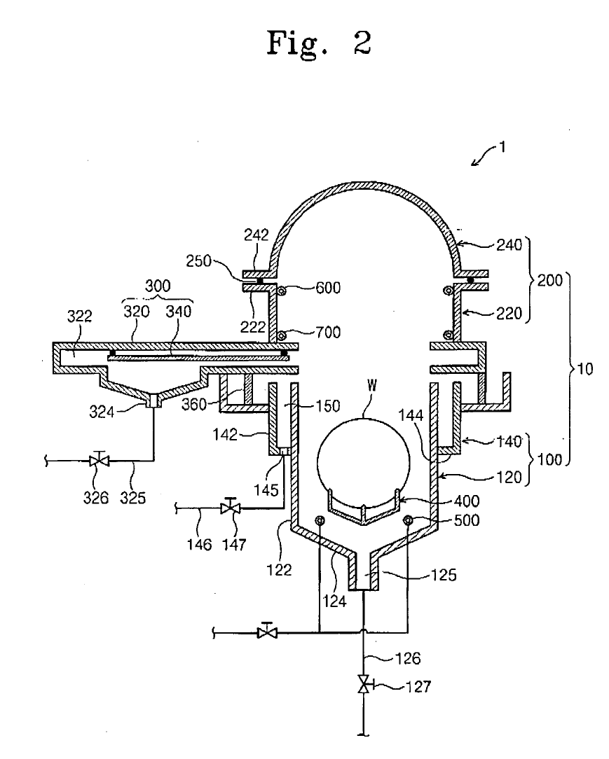

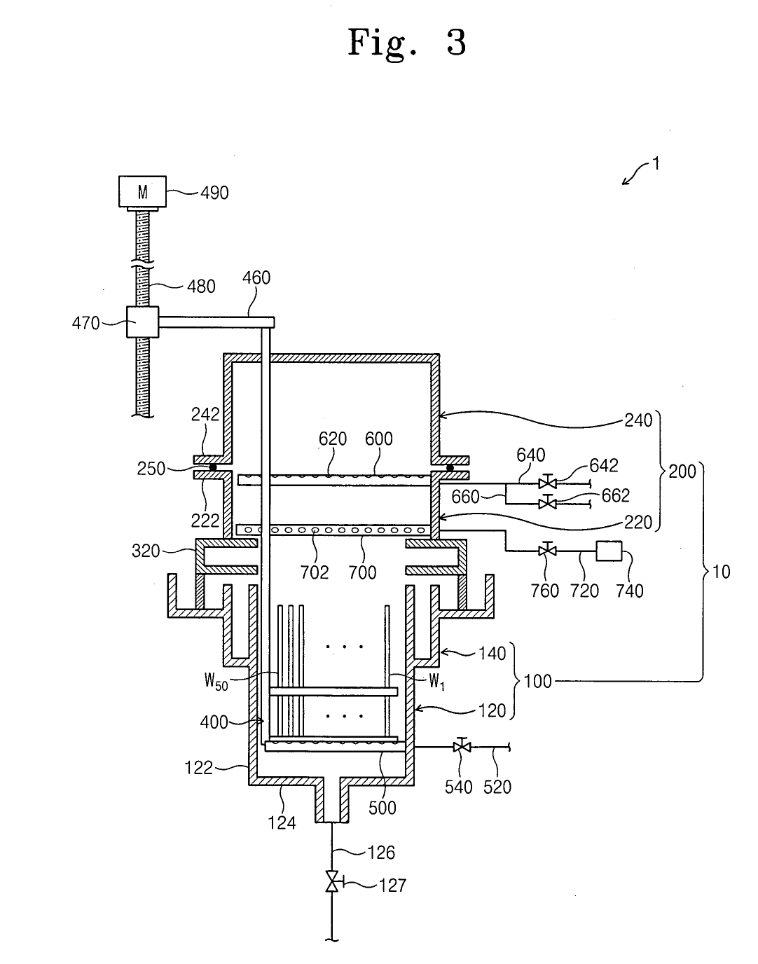

FIGS. 2 and 3 are, respectively, a regular cross-sectional view and a lateral cross-sectional view of a cleaning device 1 implemented according to a preferred embodiment of the present invention. Referring to FIGS. 2 and 3, the cleaning device 1 includes a chamber 10, a supporter 400, a cleaning liquid supply pipe 500, a drying fluid supply pipe 600, and a drying fluid exhaust pipe 700. The chamber 10 includes a treating room 100 and a drying room 200. In the treating room 100, a chemical solution processing process and a rinsing process are performed. In the drying room 200, a drying process is performed. The treating room 100 includes an inner bath 120 where the supporter 400 is located in performing a process and an outer bath 140 located to cover the inner bath 120.

The inner bath 120 has a quadrangular sidewall 122 and a bottom surface 124. An upper portion of the inner bath 120 is open. An exhaust port 125 is formed at a center of the bottom 124 of the inner bath 120. The exhaust port 125 is connected to a pipe 126 in which an open-and-shut valve 127 is installed. The bottom 124 of the inner bath 120 has a sloped-shape (see FIG. 2) so as to easily exhaust the cleaning solution filling the inner bath 120. The pipe 126 is vertical to the bottom surface 124 of the inner bath 120 in order that the cleaning solution filled in the inner bath 120 is exhausted by gravity.

The outer bath 140 is fixedly combined with the inner bath 120 to cover upper sidewalls 122 of the inner bath 120. The outer bath 140 includes rectangular parallelepiped-shaped sidewalls 142 and a bottom surface 144 extended from the rectangular parallelepiped-shaped sidewalls 142 to the sidewalls 142 of the inner bath 120. An upper portion of the outer bath 140 is open. A predetermined space is formed between the sidewall 142 of the outer bath 140 and the sidewall 122 of the inner bath 120, thereby forming an overflow section for the cleaning solution used in the inner bath 120. An exhaust port 145 is formed at the bottom 144 of the outer bath 140. The exhaust port 145 is connected to the pipe 146 for exhausting a cleaning solution inlet from the outer bath 140 to the outside. An open-and shut valve 147 for opening-and-shutting a path is installed in the pipe 146.

A drying room 200 is placed over a treating room 100. The drying room 200 includes a rectangular parallelepiped sidewall 220 and a semicircular cap 240. A bottom of the drying room 200 is open to the treatment room 100. A flange 222 protruded to the outside is formed on an upper portion of the sidewalls 220. A flange 242 protruded to the outside is formed on a lower portion of the cap 240 to correspond to the flange 222. The cap 240 is removable from the sidewalls 220, and an O-ring 250 for sealing the drying room 200 from the outside is installed in the flange of the cap 240 or the flange 222 of the sidewalls 220.

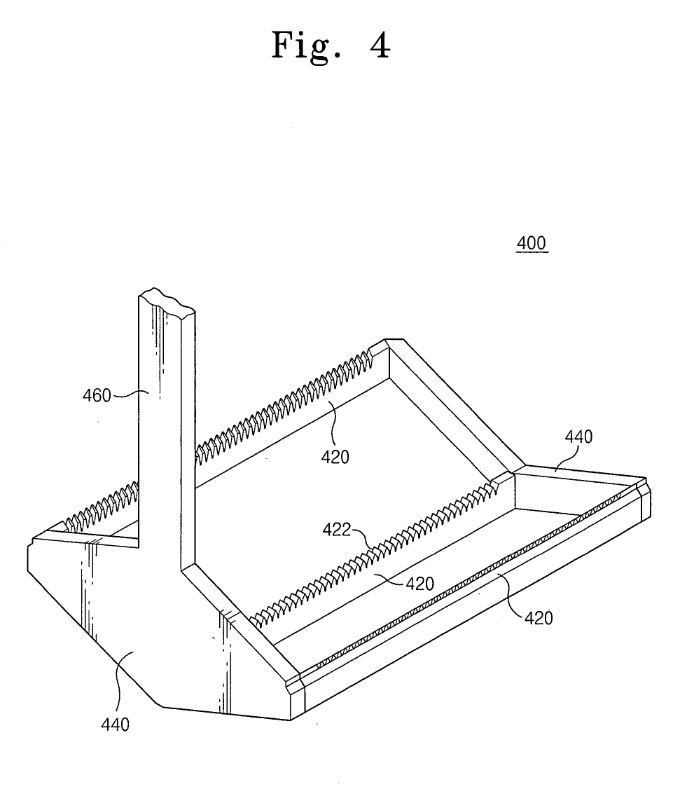

A plurality of wafers W are disposed on a supporter 400 during the cleaning process. Referring to FIG. 4, supporters 400 include supporting loads 420, a side panel 440, and a moving load 460. Slots 422 are formed in each of supporting loads 420. A part of a wafer W is inserted in the slots 422. During processing, the wafers W are disposed on the supporter 400 so that they are arranged in a line with surfaces of one wafer parallel with complementary surfaces from adjacent wafers. Three supporting loads 420 may be arranged, and about fifty sheets of wafers W may be disposed on the supporter 400. The side panel 440 connecting the supporting loads 420 is arranged at both sides of the supporting load 420. The end of the respective supporting loads 420 is fixedly combined with the side panel 440. The moving load 460 is extended upward from the one side panel 440 and penetrates a hole formed at the cap 240 of the drying room 200 formed through an upper portion of the chamber 10 (see, e.g., FIG. 3). The end of the moving load 460 is combined with a bracket 470, and a screw 480 is inserted in a hole formed at the center of the bracket 470. The screw is rotated by a motor 490, thereby lifting or lowering the moving load 460 up and down within and between treating room 100 and drying room 200.

Referring to FIG. 2 again, a breaking unit 300 is arranged between the treating room 100 and the drying room 200. The breaking unit 300 includes a separating plate 340 and a separating plated housing unit 320. The separating plate 340 has a separating plate for opening-and-shutting a space between the treating room 100 and the drying room 200. In addition, when the treating room 100 and the drying room 200 are opened, the separating plate 340 is located in the separating plate housing unit 320. The separating plate housing unit 320 is arranged between the treating room 100 and the drying room 200, and is formed to be extended from one sidewall of the chamber 10 to the other sidewall of the chamber 10. The separating plate housing unit 320 has a space 322, which is opened to the chamber 10. In addition, the separating plate 340 is located in the above-mentioned space 322 when the space between the treating room 100 and the drying room 200 is opened. An exhaust hole 324 is formed in the separating plate housing unit 320. A pipe 325 with an open-and-shut valve 326 is connected to the exhaust hole 324. The separating plate housing unit 320 is supported by the supporting plate 360, which positioned higher than the inner bath 120. The separating plate 340 is horizontally moved from the space in the separating plate housing unit 320 to the space between the treating room 100 and the drying room 200, thereby closing one off from the other.

Referring to FIG. 3 again, a cleaning solution supply pipe 500 is installed in the treating room 100. The cleaning solution supply pipe 500 receives a cleaning solution from a cleaning solution storage unit (not shown) by an external pipe 520. A valve 540 for opening-and-shutting is installed in an internal path in the external pipe 520. The cleaning solution pipe 500 is located under the supporter 400, which is located in the treating room 100. Additionally, the cleaning solution supply pipe 500 is inserted into the treating room 100 by a hole, which is formed at one sidewall of the treating room 100. Moreover, the cleaning solution supply pipe 500 is parallel to an arrangement direction of the wafers W. One or a plurality of cleaning solution supply pipes 500 may be arranged. During a chemical solution treatment process, it is possible to remove residual particles on the wafers W, metal contaminants such as copper, or contaminants such as native oxide layers using chemicals such as fluorine. During a rinsing process, the residual chemical solution on the wafers W can be removed using deionized water as a cleaning solution. The chemical solution and deionized water may be provided in the treating room 100 through the same cleaning solution pipe 500. Alternatively, the chemical solution and deionized water are selectively provided in the treating room 100 by different supply pipes.

In the event that chemicals are provided in the inner bath 120, and the wafers W are immersed in chemicals, the separating plate 340 is moved between the treating room 100 and the drying room 200 to separate the treating room 100 and the drying room 200. A chemical processing process with respect to the wafers W is performed in the treating room 100. After that, deionized water is provided to the inner bath 120 to perform a rinsing process. Deionized water overflowing the inner bath 120 into the outer bath 140 is exhausted to the outside by the pipe. If the rising process is completed, the separating plate 340 is moved into the separating plate housing unit 320 so that the treating room 100 and the drying room 200 are opened to one another. The wafers W are moved to the drying room 200 via motor 490, and the separating plate 340 is moved to the space between the drying room 200 and the treating room 100. Then, a drying process is performed.

A drying fluid supply pipe 600 for providing a drying fluid is installed in the drying room 200. The drying fluid supply pipe 600 is inserted through sidewalls 220 adjacent to an upper sidewall in the drying room 200 and run parallel with an arrangement direction of the wafers W. It is preferable that the drying fluid supply pipe 600 is placed at both sides of the wafers W. A plurality of injection ports 620 are formed in the drying fluid supply pipe 600. The injection ports 620 are configured to be open toward an upper portion of the drying room 200. The injection ports 620 have the same diameter and are formed to have regular intervals with each other. The injection port 620 may be selectively formed of a slit. The drying fluid includes an alcohol vapor or a drying gas. The alcohol vapor removes deionized water attached on the wafer, and the drying gas acts to evaporate residual alcohol vapor on the wafer. A pipe 640 connected to an external alcohol vapor supply unit (not shown) and a pipe connected to a drying gas supply unit (not shown) are combined in the drying fluid supply pipe 600. Valves 642 and 662 for opening-and-shutting an internal path of the pipes 640 and 660 are mounted in each of pipes 640 and 660, respectively. The alcohol vapor and the drying gas are provided to the drying room 200 through the same drying fluid supply pipe 600. Alternatively, the alcohol vapor and the drying gas may be selectively provided to the drying room 200 by different supply pipes. A heated nitrogen gas and isopropyl alcohol (hereinafter referred to as “IPA”) are used as the drying gas and alcohol, respectively. Alternatively, inert gas is used as the drying gas, and ethylglycol, 1-propanol, 2-propanol, tetrahydrofurane, 1-butanol, 2-butanol, methanol, ethanol, acetone, or dimethylether may be used as alcohol. The alcohol vapor is transferred to the treating room 100 by carrier gases such as nitrogen gases.

The drying fluid supplied in the drying room 200 is exhausted to the outside by an exhaust pipe 700. According to an embodiment, the exhaust pipe 700 is located in the drying chamber 200 and is coupled to external pipe 720. A sucking device for pulling a fluid from the drying room 200 and a valve 740 for opening-and-shutting an internal path are installed in the pipe 720. A pump 740 may be used as the sucking device. The exhaust pipe 700 is extended from the end of the pipe 720 and into the drying room 200. The exhaust pipe 700 and the pipe 720 may be formed in one united body and selectively have a structure escapable with the pipe 720. The exhaust pipe 700 is inserted through the sidewalls 220 of the drying room 200 and is disposed within the drying room chamber in parallel with an arrangement direction of the wafers W along both sides in the drying room 200. That is, it is preferable that the exhaust pipe 700 be installed along both sides of the wafers W. A plurality of exhaust ports 702 are formed in the exhaust pipe 700. Wafers W1, W2, . . . , W50 are staged within the drying room 200 in which the exhaust pipe 700 is inserted. The order of the wafers W1, W2, . . . , W50 starts from the locations closest to the sidewalls 220 of the drying room 200. The exhaust pipe 700 should be long enough to extend to wafer W50, which is located at the end of the chamber.

Exhaust ports 702 are formed as a hole. A plurality of exhaust ports 702 are formed in each of the exhaust pipes 700. Preferably, the number of exhaust ports 702 included in each of the exhaust pipes 700 are from three to the number of the wafers W inserted for cleaning (e.g. fifty). The exhaust port 702 of the exhaust pipe 700 is formed at a portion adjacent to the wafer W1 located at the one end and a portion adjacent to the wafer W50 located at the other end. The rest of exhaust ports 702 may be formed between the portions at a uniform interval. Where the number of the exhaust ports 702 is the same as that of the wafers W, the exhaust port 702 may be formed at a position adjacent to the respective wafers W. The shape of the exhaust port aperture can be circular as well as other configurations.

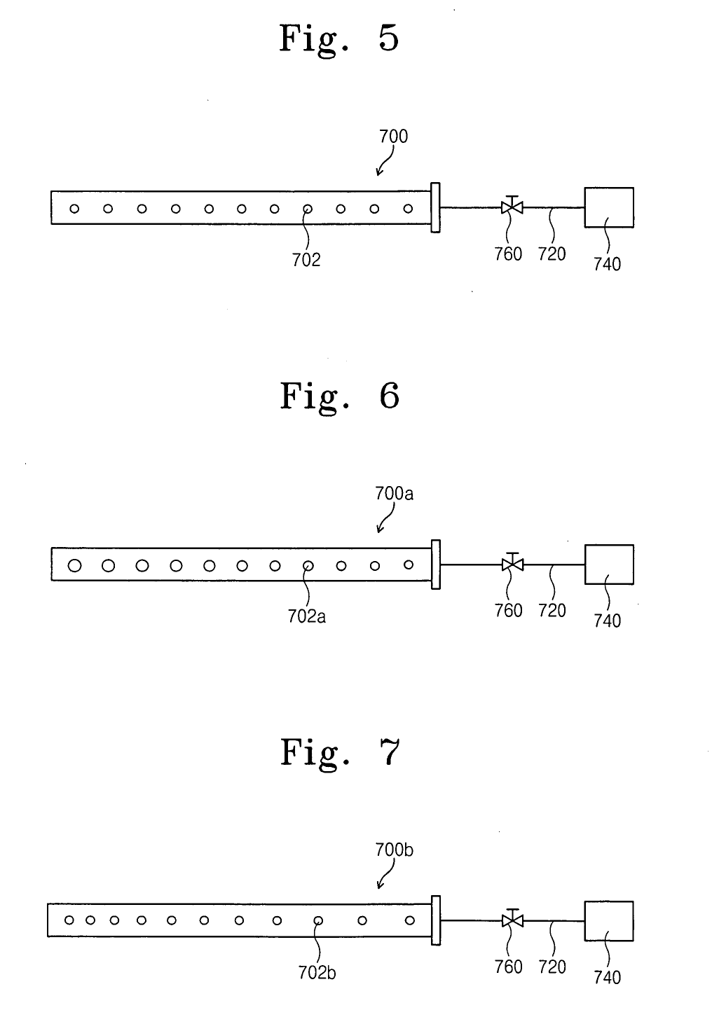

In accordance with an example, as shown in FIG. 5, the exhaust ports 702 are formed having the same diameter and interval along the exhaust pipe 700. In the embodiment where the exhaust ports 702 have the same diameter, the exhaust amount via the respective exhaust ports 702 gradually decreases the further the port is from the pump 740 along a flow path within the pipe.

In order to prevent the drying fluid from being released unevenly within the drying chamber, the exhaust ports 702a may be formed with different diameters at the same interval in the exhaust pipe 700a as shown in FIG. 6. In other words, the diameter of the exhaust port 702a may be gradually increased for those exhaust ports 702a further away from the pump 740 than closer to it. Alternatively, exhaust ports 702b with the same diameter may be formed at different intervals in the exhaust pipe 700b as shown in FIG. 7. For example, the interval between the exhaust ports 702b may become narrow as they are away from the pump 740. As not shown, the exhaust ports have different size and interval according to a formation location thereof.

In the above-mentioned examples, the size and interval of the exhaust ports are equal or varied according to a regular rule. Alternatively, the size or interval of the exhaust ports may become different in only specific region according to a drying state of wafers after drying.

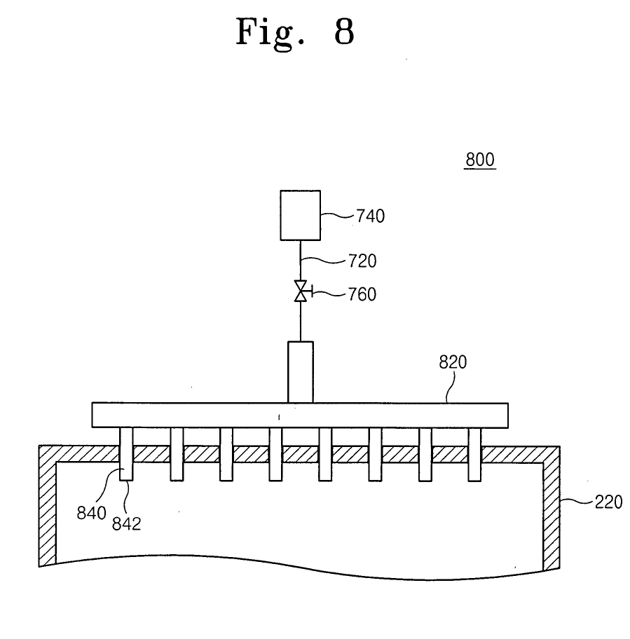

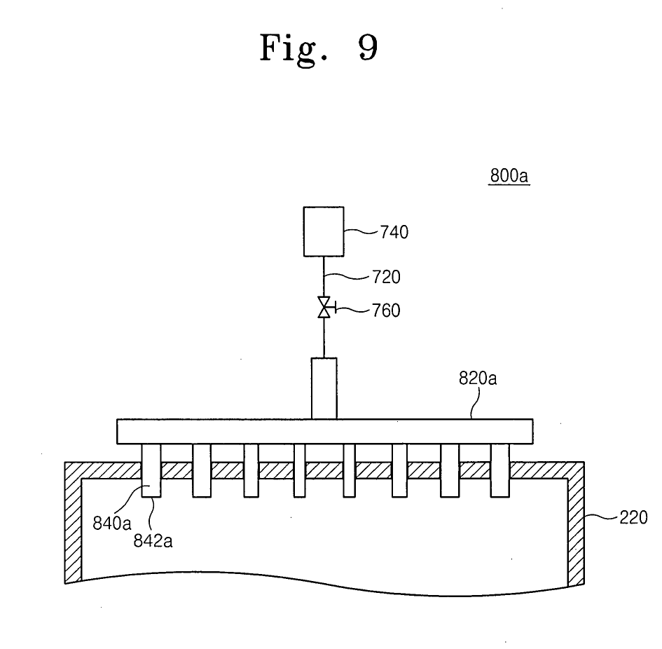

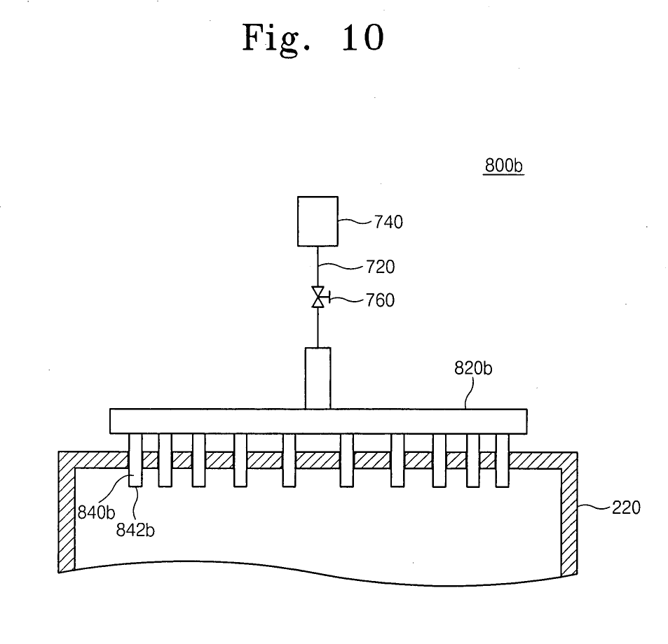

In accordance with another embodiment, an exhaust pipe 800 includes a main pipe 820 and a plurality of subsidiary pipes 840. FIG. 8 schematically shows the exhaust pipe installed within the drying room 200. The main pipe 820 is installed on the outside of sidewalls of the drying room 200 in parallel with an arrangement direction of wafers W. It is preferable that the main pipe 820 is installed at both sides of the wafers W, respectively. The plurality of subsidiary pipes 840 is branched perpendicularly from the respective main pipes 820. A pipe 720 connected to a suction device such as the pump 740 is combined at the center of the main pipe 820. Each of the subsidiary pipes 840 is inserted into sidewalls of the drying room 200. An exhaust port 842 is formed at the end of each respective subsidiary pipe 840. The diameter and intervals of the subsidiary pipes 840 may be changed depending on a formation location of the subsidiary pipe 840. That is, as shown in FIG. 9, the diameter of each subsidiary pipe 840a gradually increases for subsidiary pipes closer to each end of the main pipe 820a. In addition, as shown in FIG. 10, the intervals between the subsidiary pipes 840b may become narrower for pipes near both ends of the main pipe 820a as opposed to those closer to the center. As compared with the exhaust pipe of FIG. 5, the exhaust 800 of FIG. 8 is advantageous in that there is a small difference between the exhaust ports.

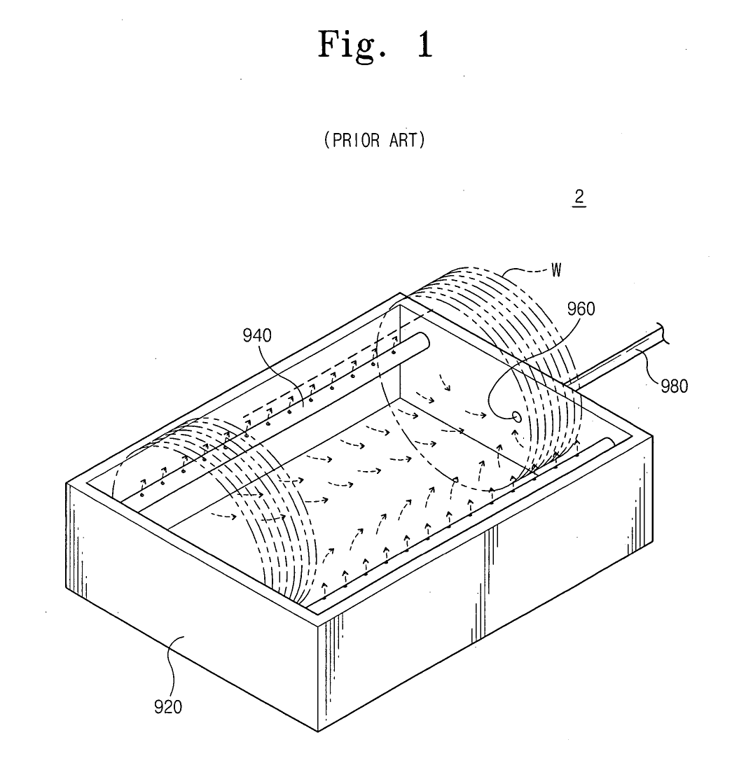

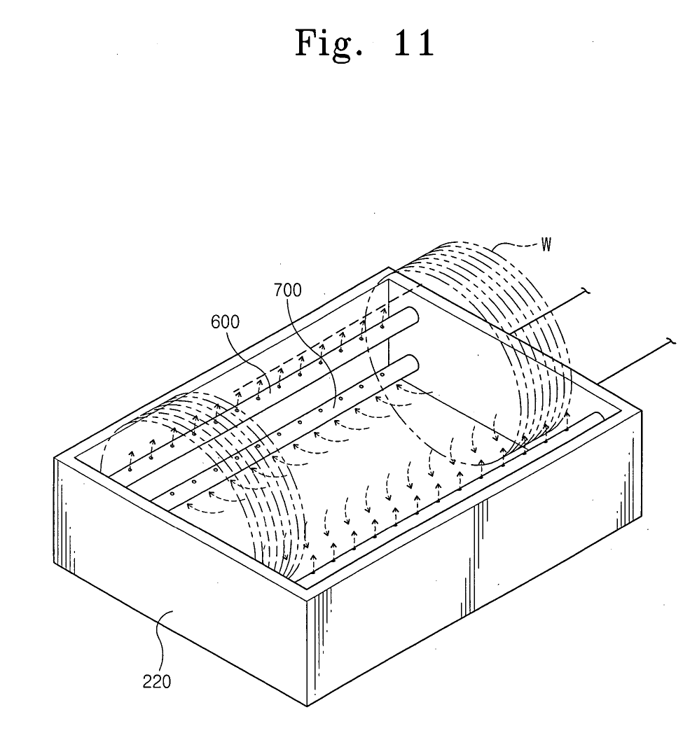

FIG. 11 shows a flowing of a fluid in a drying room 200 using an exhaust pipe 700. Referring to FIG. 11, drying fluid supply pipes 600 are arranged at both sides in the drying room 200 along an arrangement direction of the wafers W. The exhaust pipe 700, where a plurality of exhaust ports 702 are formed, is arranged under the drying fluid supply pipes 600. Accordingly, the flowing of the fluids is not inclined to one direction as shown in FIG. 1, and the fluids are uniformly exhausted along the arrangement direction of the wafers W as a whole. Thus, since the drying fluid is provided and exhausted relatively uniformly to all wafers W, it is possible to improve a drying efficiency.

While the invention has been described by way of example such as a cleaning device 1 includes a drying room 200 and a respectively separated treating room, it is to be understood that the invention is not limited to the disclosed embodiments. In addition, the invention is applicable to a device for only drying wafers and a device for simultaneously performing chemical processing, rinsing, and drying wafers in the same space.

What is claimed is:

1. An apparatus for cleaning one or more semiconductor substrates comprising:
a chamber having a drying room in which the one or more substrates are to be dried;
a supporter disposed within the drying room and adapted to support the one or more substrates in an arrangement direction during a drying process;
at least one supply pipe for providing a drying fluid into the drying room; and
at least one exhaust pipe in which a fluid in the drying room is exhausted, said exhaust pipe including a plurality of exhaust ports arranged along the arrangement direction and adapted to admit the fluid therethrough and into the exhaust pipe for evacuation of the fluid from the drying room.

2. The apparatus of claim 1, the supporter further including slots formed therein along a length of the supporter so that a substrate mounted within the supported is arranged in parallel with an adjacent substrate mounted therein.

3. The apparatus of claim 1, wherein the number of exhaust ports arranged on the exhaust pipe is between 3 and the number of substrates mounted within the supporter.

4. The apparatus of claim 2, wherein the exhaust pipe is located at a lower portion in the drying room and the supply pipe is disposed parallel to the arrangement direction and above the exhaust pipe.

5. The apparatus of claim 2, wherein the exhaust pipe is located in the drying room, and the exhaust ports are formed as a hole in the exhaust pipe.

6. The apparatus of claim 5, wherein the exhaust pipe is connected to a suction device adapted to suck a fluid from the drying room into the exhaust pipe, and wherein an aperture size of the exhaust ports increases as the exhaust ports become more distant from the suction device along a suction path.

7. The apparatus claim 5, wherein the exhaust pipe is connected to a suction device adapted to suck a fluid from the drying room into the exhaust pipe, and wherein the exhaust ports are closer together as the exhaust ports become more distant from the suction device along a suction path.

8. The apparatus of claim 3, wherein each of the exhaust ports includes:
a main pipe arranged outside of the drying room along an arrangement direction of the substrates disposed on the supporter;
a plurality of subsidiary pipes, each having an exhaust port, branched from the main pipe and received through a sidewall of the drying room; and
a pipe connected to the main pipe and having a suction device coupled thereto.

9. The apparatus of claim 9, wherein the pipe is connected to a center of main pipe.

10. The apparatus of claim 1, wherein the drying fluid includes isopropyl alcohol.

11. An apparatus for cleaning a semiconductor substrate comprising:
a chamber having a treating room where a chemical processing process or a rinsing process with respect to the substrate is adapted to be performed, and a drying room in which a drying process with respect to the substrate is adapted to be performed, the drying room arranged over the treating room;
a supporter arranged in the chamber and being movable between the treating room and the drying room;
a movable separating plate adapted to be moved between the treating room and the drying room;
a supply pipe mounted at an upper portion within the drying room and providing a drying fluid to a semiconductor substrate disposed thererin; and
an exhaust pipe where a fluid in the chamber is exhausted, said exhaust pipe arranged along the arrangement direction and adapted to admit the fluid therethrough and into the exhaust pipe for evacuation of the fluid from the drying room.

12. The apparatus of claim 11, wherein the exhaust pipe includes a plurality of exhaust ports disposed along the exhaust pipe in the arrangement direction.

13. The apparatus of claim 12, wherein the number of exhaust ports arranged on the exhaust pipe is between 3 and the number of substrates mounted within the supporter.

14. The apparatus of claim 11, wherein the exhaust pipe is located at a lower portion in the drying room and the supply pipe is disposed parallel to the arrangement direction and above the exhaust pipe.

15. The apparatus of claim 11, wherein the exhaust pipe is located in the drying room, and the exhaust ports are formed as a hole in the exhaust pipe.

16. The apparatus of claim 15, wherein the exhaust pipe is connected to a suction device adapted to suck a fluid from the drying room into the exhaust pipe, and wherein an aperture size of the exhaust ports increases as the exhaust ports become more distant from the suction device along a suction path.

17. The apparatus claim 15, wherein the exhaust pipe is connected to a suction device adapted to suck a fluid from the drying room into the exhaust pipe, and wherein the exhaust ports are closer together as the exhaust ports become more distant from the suction device along a suction path.

18. The apparatus of claim 13, wherein each of the exhaust ports includes:
a main pipe arranged outside of the drying room along an arrangement direction of the substrates disposed on the supporter;
a plurality of subsidiary pipes, each having an exhaust port, branched from the main pipe and received through a sidewall of the drying room; and
a pipe connected to the main pipe and having a suction device coupled thereto.

19. A method for drying a semiconductor wafer comprising:
mounting one or more wafers on a supporter in an arrangement direction;
releasing drying fluid adjacent the one or more wafers from a plurality of apertures disposed parallel to the arrangement direction along a drying fluid supply pipe; and
exhausting the drying fluid adjacent the one or more wafers through a plurality of exhaust apertures disposed parallel to the arrangement direction along a drying fluid exhaust pipe.

20. The method of claim 19, further including releasing an alcohol vapor adjacent the wafers prior to the step of releasing the drying fluid.

21. The method of claim 20, wherein the alcohol vapor is an isopropyl alcohol.

22. The method of claim 20, wherein the alcohol vapor is selected from the group consisting of: ethylglycol, 1-propanol, 2-propanol, tetrahydrofurane, 1-butanol, 2-butanol, methanol, ethanol, acetone, or dimethylether.
